(19) United States
(12) Patent Application Publication
(10) Pub. No.: US 2005/0177311 A1
(43) Pub. Date: Aug. 11, 2005

(54) Information server with a database of information about particular locations and a telephone for remotely accessing and querying the same

(76) Inventor: Nicholas David Lane Thorne, Southhampton (GB)

Correspondence Address: PHILIPS INTELLECTUAL PROPERTY & STANDARDS, P.O. BOX 3001, BRIARCLIFF MANOR, NY, 10510, US

(21) Appl. No.: 10/509,415

(22) PCT Filed: Feb. 14, 2003
(86) PCT No.: PCT/IB03/00584

(30) Foreign Application Priority Data
Mar. 28, 2002 (GB) 0207295.7

(51) Int. Cl. G06F 7/00; G06F 17/30

(52) U.S. Cl. 702/19; 707/1

(57) ABSTRACT

An information server and corresponding telephone are disclosed wherein the server containing a database of records with each record being identified by a location tag and containing information about a particular location; and wherein at least some of the location tags are neither descriptive of the name of organisations which conduct business at the corresponding particular locations nor form part of the address of those locations. Using the corresponding communications telephone, a user may remotely access and query the database using the telephone keypad to enter a location tag to retrieve information about a particular location contained in a record identified by that location tag. Also disclosed is a sign located at a particular location and conveying a location tag of the aforementioned type and, in particular, in the form of a wall plaque appended to a building wherein information contained in a record identified by that location tag relates to an organisation which conducts business in that building.

The invention relates to an information server with a database of information about particular locations, a telephone for remotely accessing and querying the database and a related sign.

In the United Kingdom, the government organisation Ordnance Survey has a website at url http://www.ordnancesurvey.gov.uk which discloses the use what it refers to as Topographic Identifiers (TOIDs) which are 16 digit numbers which label map features such as points, lines and areas. The stated purpose of these TOIDs is to provide a consistent, flexible and interchangeable mapping format whereby, for example, map features can be viewed by classification.

U.S. Pat. No. 4,577,062 (Hilleary et al.) discloses a method of dispensing particular information automatically from a changing data source to a user whereby the user accesses the information by dialling the dissemination service using telephone equipment. The caller's call and subsequent dialled digital sequences, corresponding by prearrangement to specific information requests, are automatically processed. The information from a data base is transmitted to the caller by audible synthesised speech signal through the caller's telephone.

U.S. Pat. No. 6,225,944 (Hayes) discloses a method of manual reporting of location data in a mobile communications network. In particular, at lines 25 to 30 of column 2 disclose where “the method gathers location information from a Global Positioning System (GPS) receiver and then converts the location information into a Teletype/Telephony Device for the Deaf (TTY/TDD) format before transmitting the location information”. As disclosed at lines 23 to 25 of column 5, this may be done using transmission protocols including Baudot, V21, DTMF (Dual Tone Multi-Frequency), and EDT (European Deaf Telephony), and the V.18 protocol”.

In accordance with the present invention, a server and corresponding telephone are provided wherein the server containing a database of records with each record being identified by a location tag and containing information about a particular location; and wherein at least some of the location tags are neither descriptive of the name of organisations which conducts business at the corresponding particular locations nor form part of the address of those locations. Using the corresponding communications telephone, a user may remotely access and query the database using the telephone keypad to enter a location tag to retrieve information about a particular location contained in a record identified by that location tag.

As access is with a telephone keypad, it is convenient if each location tag consists only of numbers 0 to 9 and, optionally, star (*) and hash (#) symbols.

Information about a particular location is intended to include, for example, co-ordinates of that location (i.e. latitude, longitude etc.), the address of that location, directions to that location and the identity of organisations which conducts business at that particular location.

Also provided in accordance with the present invention is a sign located and conveying a location tag of the aforementioned type and, in particular, in the form of a wall plaque appended to a building wherein information contained in a record identified by that location tag relates to an organisation which conducts business in that building.

Where information about a particular location is retrieved from the server and contains either the co-ordinates of that location, the address of that location or directions to that location, the telephone may be configured to provide to the user directions to that location from the present location of the telephone. Where this is the case, it is convenient if the telephone comprises position determining means to whereby it is able to determine its own location, for example such as a GPS receiver, telephone network positioning circuitry and the like.

The inventor has realised that it is may be desirable for a mobile user carrying a mobile telephone to access information about particular locations on the move, and in particular about buildings and the organisations located therein. For example, the application of an arbitrary, numerical location tag on a sign appended to a building provides an immediate reference with which a user may query a database using a telephone

The present invention will now be described, by way of example only, with reference to the accompanying schematic drawings in which:

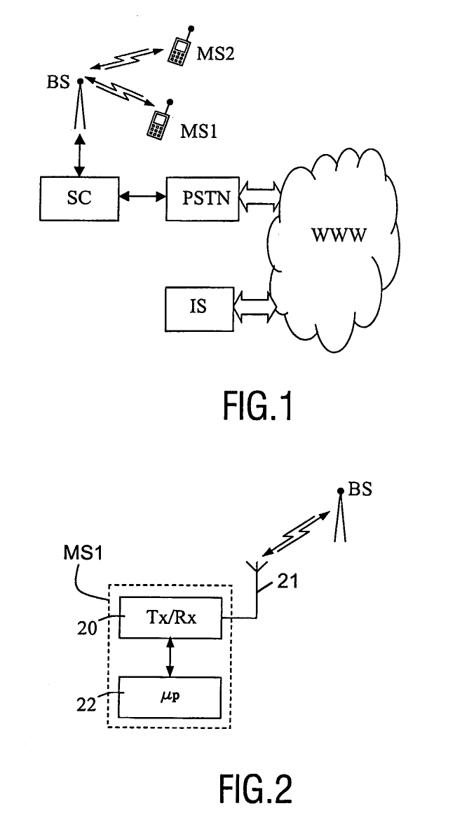

FIG. 1 shows mobile cellular telephones MS1 and MS2 communicating via a nearby cellular telephone network base station BS and a public switched telephone network (PSTN) with a remote, Internet based information server (IS) in accordance with the present invention;

FIG. 2 shows the mobile cellular telephone MS1 of FIG. 1 in greater detail;

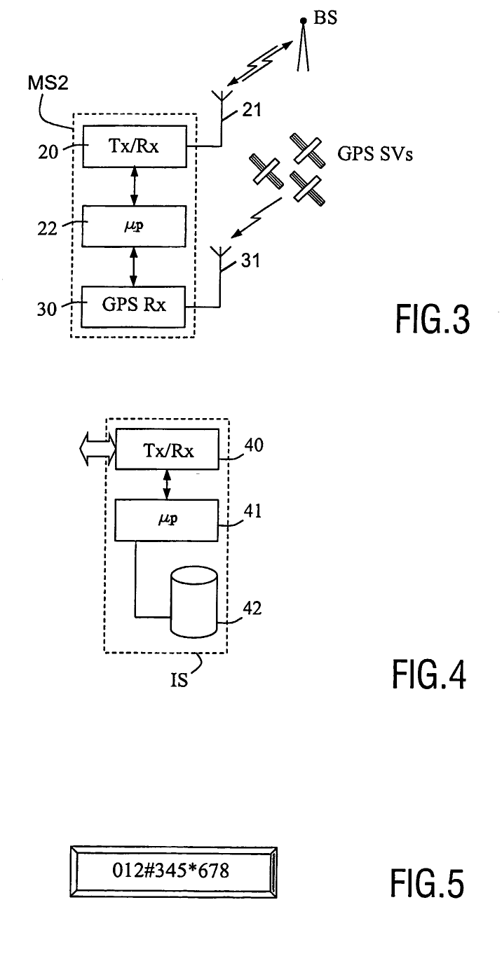

FIG. 3 shows the mobile cellular telephone MS2 of FIG. 1 in greater detail;

FIG. 4 shows the remote, Internet based information server (IS) of FIG. 1 in greater detail; and

FIG. 5 shows a wall plaque in accordance with the present invention.

FIG. 1 shows mobile cellular telephones MS1 and MS2 in possession of respective users (not shown) and registered with nearby cellular telephone network base station BS facilitating voice and data communication with that base station and corresponding cellular telephone network. Data communication is intended to include sending text messages (for example using the short message service (SMS) protocol) and accessing the Internet (for example using WAP or i-mode protocols). In particular, mobile telephones MS1 and MS2 are communicating via the base station and a public switched telephone network PSTN with a remote, Internet based information server IS in a manner according to the present invention.

In FIG. 2, telephone MS1 is shown in greater detail comprising a communications transmitter (Tx) and receiver (Rx) 20 connected to a communications antenna 21 and controlled by a communications microprocessor (μp) 22 for communication with the base station BS with which it is registered. FIGS. 3 shows telephone MS2 in greater detail configured similarly to telephone MS1 except that telephone MS2 further comprises a GPS receiver (GPS Rx) 30 connected to a GPS antenna 31. Also, the communications microprocessor (μp) 22 is further configured to acquire and track GPS signals for the purpose of deriving pseudorange information from which the location of the mobile telephone can be determined using conventional navigation algorithms. Such methods for GPS signal acquisition, tracking and position determination are well known, for example, GPS Principles and Applications (Editor, Kaplan) ISBN 0-89006-793-7 Artech House. Also, the design and manufacture of telephones of the type of telephones MS1 and MS2 are well known and those parts which do not directly relate to the present invention will not be elaborated upon here further.

FIG. 4 shows the remote, Internet based information server IS in greater detail. As illustrated, the server is arranged to receive, and deliver, signals to the Internet and includes a transmitter (Tx) and receiver (Rx) 40 for receiving queries from mobile telephones MS1 and MS2. The server further includes a database 42 under control of a microprocessor (μp) 41 wherein the database's records containing information about respective places which are indexed by a location tag, the format of which is a number which may optionally be interspersed with the symbols # and * which can be found on the keypads of telephones MS1 and MS2.

Information about a particular location is obtained in accordance with the present invention as illustrated in the following examples:

### EXAMPLE 1

Suppose that a user in possession of telephone MS1 has received a text message from a friend with whom the user is intending to meet and wherein the text message states that the friend is at “012#345*678” which refers to a location tag on a plaque as shown in FIG. 5 which is hung on a wall of the entrance to a restaurant in which restaurant the friend is waiting to meet the user.

At the time when the location tag was created and the plaque first placed at the restaurant, a record was created in the database held on the information server IS, the record including the name and address of the restaurant, and generic directions to the restaurant wherein the entry was tagged by the location tag “012#345*678”.

The user of telephone MS1 connects to the Internet using their mobile cellular telephone in a conventional manner by transmitting and receiving data from the telephone MS1 via the base station BS, a cellular network system controller (SC) and a public switched telephone network PSTN. The user then accesses the information server (IS) via the Internet and queries the database held on the information server by sending the location tag “012#345*678” to the information server. The information server (IS) replies sending the name and address of the restaurant, and generic directions to the restaurant, i.e. the contents of the record created when the location tag was created. In addition, the information server provides an url to a mapping website which if selected, would display a map of the area in which the restaurant is located.

Thus, upon querying the database, the information server replies with said details which enables the user of telephone MS1 to find the restaurant in order to meet the user's friend.

### EXAMPLE 2

As example 1 except that a user using telephone MS2 may access the information server IS and send to the information server the user's current position obtained using the GPS receiver of telephone MS2 in addition to the location tag “012#345*678”. The information server replies sending specific directions from the user's current position to the restaurant.

At the time of writing, the mapping website http://www.multimap.co.uk enables an url to be created which if selected directs a user to a map of a predefined area. Similarly, the same website will also provide directions from one location to another and accordingly, the mechanisms for this functionality are not described here in detail.

As an alternative to a GPS receiver in example 2 above, other forms of positioning technology may be used including telephone network positioning such as E-OTD and other GPS type solutions such as GLONASS and GALILEO.

From reading the present disclosure, other modifications will be apparent to persons skilled in the art. Such modifications may involve other features which are already known in the design and use of computer systems and component parts thereof and which may be used instead of or in addition to features already described herein. Although claims have been formulated in this application to particular combinations of features, it should be understood that the scope of the disclosure of the present application also includes any novel feature or any novel combination of features disclosed herein either explicitly or implicitly or any generalisation of one or more of those features which would be obvious to persons skilled in the art, whether or not it relates to the same invention as presently claimed in any claim and whether or not it mitigates any or all of the same technical problems as does the present invention. The applicants hereby give notice that new claims may be formulated to such features and/or combinations of such features during the prosecution of the present application or of any further application derived therefrom.

1. An information server containing a database of records wherein each record is identified by a location tag and contains information about a particular location; wherein at least some of the location tags are neither descriptive of the name of organisations which conducts business at the corresponding particular locations nor form part of the address of those locations; and wherein a user may remotely access and query the database using a telephone keypad to enter a location tag to retrieve information about a particular location contained in a record identified by that location tag.

2. A server according to claim 1 wherein each location tag consists only of numbers 0 to 9 and star (*) and hash (#) symbols.

3. A server according to claim 2 wherein each location tag consists only of numbers 0 to 9.

4. A server according to any preceding claim wherein at least one record contains the co-ordinates of a particular location.

5 A server according to any preceding claim wherein at least one record contains the address of a particular location.

6. A server according to any preceding claim wherein at least one record contains directions to a particular location.

7. A server according to any preceding claim wherein at least one record contains information about an organisation which conducts business at a particular location.

8. A telephone adapted to connect to an information server containing a database of records wherein each record is identified by a location tag and contains information about a particular location; wherein at least some of the location tags are neither descriptive of the name of organisations which conducts business at the corresponding particular locations-nor form part of the address of those locations; and wherein a user may remotely access and query the database using the telephones keypad to enter a location tag to retrieve information about a particular location contained in a record identified by that location tag.

9. A telephone according to claim 8 wherein the database can be queried by a user entering or having previously entered a location tag on the telephone's keypad using only numbers 0 to 9 and star (*) and hash (#) symbols.

10. A telephone according to claim 9 wherein the database can be queried by a user entering or having previously entered a location tag on the telephone's keypad using only numbers 0 to 9.

11. A telephone according to any of claims 8 to 10 wherein the information about a particular location retrieved from the server contains either the co-ordinates of that particular location, the address of that particular location or directions to that particular location; and wherein the telephone is configured to provide to the user directions to that particular location from the telephone's present location.

12. A telephone according to claim 11 wherein the telephone comprises position determining means to determine its present location.

13. A sign located at a particular location and conveying a location tag which identifies a particular record in a database containing information about that location, wherein the location tag is one of many such location tags held in the data base, at least some of which are neither descriptive of the name of an organisation which conducts business at that location nor forms part of the address of that location.

14. A sign according to claim 13 wherein the location tag it conveys is neither descriptive of the name of an organisation which conducts business at that location nor forms part of the address of that location.

15. A sign according to claim 13 or claim 14 wherein the location tag consists exclusively of numbers 0 to 9, star (*) and hash (#) symbols.

16. A sign according to claim 15 wherein the location tag consists exclusively of numbers 0 to 9.

17. A sign according to any of claims 13 to 16 in the form of a wall plaque appended to a building wherein information contained in a record in the database identified by that location tag relates to an organisation which conducts business in that building.
